(19) United States
(12) Patent Application Publication
(10) Pub. No.: US 2025/0333593 A1
(43) Pub. Date: Oct. 30, 2025

(54) Fire Resistant Two-Part System

(71) Applicant: Zephyros, Inc., Romeo, MI (US)

(72) Inventors: Hamid Mortazavian, Romeo, MI (US); Ira Miller, Romeo, MI (US); Michael Czaplicki, Romeo, MI (US); Donald Paquet, Romeo, MI (US)

(21) Appl. No.: 18/685,352

(22) PCT Filed: Sep. 15, 2022
(86) PCT No.: PCT/US2022/043669

§ 371 Date: Feb. 21, 2024

Related U.S. Application Data
(60) Provisional application No. 63/244,347, filed on Sep. 15, 2021.

(51) Int. Cl. C08L 63/10; C08K 3/22; C08K 3/32; C08K 5/5313; C08K 7/22

(52) U.S. Cl. CPC C08L 63/10; C08K 3/22; C08K 5/5313; C08K 7/22; C08K 2003/2224; C08K 2003/2227; C08K 2003/323; C08K 2201/005; C08L 2201/02

(57) ABSTRACT

A fire-resistant two-part system comprising a first component and a second component. The first component comprises one or more fire resistance improving additives. The second component comprises one or more acids.

### FIELD

The present disclosure relates to a two-part system comprising a first component and a second component, the two-part system comprising one or more fire resistance improving additives. The two-part system may be advantageous to resist ignition of a reaction product or at least inhibit the spread of open flame.

### BACKGROUND

Fire resistant compositions, particularly polymers, are commonly employed in the aerospace, military, construction, and automotive industries. Fire resistance is a property of materials whereby combustion is terminated or inhibited following exposure to fire and/or non-fire source of ignition (e.g., extreme temperatures). In each different industry or application, different fire resistances are required or at least suggested. Different testing methods may also be employed to evaluate the fire resistance performance of these compositions. For instance, some methods involve exposing compositions to an open flame while other methods involve exposing compositions to extreme temperatures, even others might measure caloric content of a composition. In addition to total heat release, heat release rate may be measured.

There are several fire resistance modes that may be provided by compositions, as disclosed herein. For instance, additives to improve fire resistance may be selected for their formation of a barrier or their gaseous pyrolysis emissions that dilute gaseous fuel sources. The particular method employed may be selected depending on the end-use application of the material and thus, the type of testing methods required or suggested by each end-use application. These modes may be employed in isolation or in combination. Combining these modes may produce a synergistic effect of resisting ignition and/or inhibit the spread of open flame.

It would be desirable to provide a composition that is fire resistant in absence of any additives to increase fire resistance. It would be desirable to provide a composition that has a fire resistance performance, in absence of any fire resistance improving additives, that obviates the need for an amount of fire resistance improving additives that would otherwise diminish useful properties of the composition. It would be desirable to provide a composition, which can easily have its fire resistance modulated to suit a variety of end-use applications. It would be desirable to provide a composition that does not ignite, in absence of another ignition source, upon exposure to extreme temperatures. It would be desirable to provide a composition that at least forms a surface barrier upon exposure to an ignition source.

### SUMMARY

The present disclosure relates to a two-part system. The two-part may address at least some of the needs identified above. The fire-resistant two-part system may comprise a first component, and a second component comprising one or more acids. The fire-resistant two-part system may comprise one or more fire resistance improving additives.

The teachings herein are further directed to a fire-resistant two-part system comprising a first component; preferably comprising one or more epoxy resins, fire-resistance-improving additives, reactive diluents, additives, or any combination thereof; and a second component comprising one or more acids; optionally additionally one or more epoxy resin reaction products, reactive diluents, additives, or any combination thereof.

The fire-resistant two-part system may comprise one or more-fire resistance-improving additives. The fire-resistant two-part system may cure to form a reaction product when the first component and the second component are mixed with one another. Curing may initiate immediately upon mixing the first component and the second component with one another, preferably at room temperature (23° C.). Curing may be delayed for a time after mixing the first component and the second component with one another, preferably at room temperature (23° C.).

The fire-resistant two-part system may be free or may be substantially free of latent curing agents, curing accelerators, or both. The one or more fire resistance improving additives may be free of halogens.

The one or more fire-resistance-improving additives may include a phosphorous-based material, a metal hydroxide, or both. the phosphorous-based material is 9, 10-Dihydro-9-oxa-10-phosphaphenanthrene 10-oxide, an ammonium polyphosphate, an organic phosphinate, or any combination thereof.

The ammonium polyphosphate may be linear, preferably short linear chained (n<1000), or branched, preferably long branched chained (n>1000). The ammonium polyphosphate may be present in the first component in an amount of about 3% or more, 7% or more, or even 11% or more, by weight of the first component. The ammonium polyphosphate may be present in the first component in an amount of about 25% or less, 19% or less, or even 15% or less, by weight of the first component.

The organic phosphinate may function to decompose when heated and releases diethyl phosphinic acid in the gas phase. The organic phosphinate may be present in the first component in an amount of about 0.5% or more, 1% or more, or even 3% or more, by weight of the first component. The organic phosphinate may be present in the first component in an amount of about 9% or less, 7% or less, or even 5% or less, by weight of the first component.

The metal hydroxide may be aluminum hydroxide, magnesium hydroxide, or both.

The one or more fire-resistance-improving additives may be present in the first component in an amount of between about 0.5% and 30%, more preferably about 5% to 25%, or even more preferably about 10% to 20%, by weight of the first component. The fire-resistance-improving additives may have a particle size of about 20 microns or less, 10 microns or less, or even 5 microns or less. The fire-resistance-improving additives may have a phosphorous content of between about 15% and 35%, preferably between about 20% and 30%, or even between about 23% and 25% w/w.

The first component may comprise one or more epoxy resins. The first component may comprise one or more epoxy resins including one or more multifunctional aromatic epoxy resins, multifunctional aliphatic epoxy resins, epoxy novolac resins, silane modified epoxy resins, epoxy/elastomer adducts, or any combination thereof.

The functionality of the multifunctional aromatic and/or aliphatic epoxy resin may be about 2 or more, 3 or more, or even 4 or more. The functionality of the multifunctional aromatic and/or aliphatic epoxy resin may be about 8 or less, 7 or less, or even 6 or less. The multifunctional aliphatic epoxy resin may include epoxidized sorbitol, epoxidized soybean oil, solid epoxy novolac resins, liquid epoxy novolac resins, a reaction product of epichlorohydrin and propylene glycol, or any combination thereof. The multifunctional aliphatic epoxy resin may have an epoxy equivalent weight of about 130 g/eq to 230 g/eq, preferably about 140 g/eq to 220 g/eq, or even about 160 g/eq to 195 g/eq, according to ASTM D1652-11. The multifunctional aliphatic epoxy resin may have an epoxy equivalent weight of about 290 g/eq to 360 g/eq, preferably about 300 g/eq to 350 g/eq, or even about 310 g/eq to 340 g/eq, according to ASTM D1652-11. The multifunctional aliphatic epoxy resin may have a viscosity, measured at 25° C., of about 6,000 cP to about 20,000 cP, more preferably about 7,000 cP to 19,000 cP, or even more preferably about 8,000 cP to 18,000 cP, according to ASTM D445-21. The multifunctional aliphatic epoxy resin may have a viscosity, measured at 25° C., of about 40 cP to 90 cP, preferably about 50 cP to 80 cP, or even about 60 cP to 70 cP, according to ASTM D445-21.

The multifunctional aromatic epoxy resin includes may be a reaction product of epichlorohydrin and bisphenol A. The multifunctional aromatic epoxy resin has an epoxy equivalent weight of about 160 g/eq to 210 g/eq, preferably about 170 g/eq to 200 g/eq, or even about 182 g/eq to 192 g/eq, according to ASTM D1652-11. The multifunctional aromatic epoxy resin may have a viscosity, measured at 25° C., of about 9,000 cP to 16,000 cP, more preferably about 10,000 cP to 15,000 cP, or even more preferably about 11,000 cP to 14,000 cP, according to ASTM D445-21.

The multifunctional aromatic epoxy resin may include a reaction product of epichlorohydrin and bisphenol F. The multifunctional aromatic epoxy resin may have an epoxy equivalent weight of about 145 g/eq to 195 g/eq, preferably about 155 g/eq to 185 g/eq, or even about 165 g/eq to 175 g/eq, according to ASTM D1652-11. The multifunctional aromatic epoxy resin may have a viscosity, measured at 25° C., of about 1,000 cP to 7,000 cP, preferably about 2,000 cP to 6,000 cP, or even about 3,000 cP to 5,000 cP, according to ASTM D445-21.

The one or more epoxy resins may be present in an amount of between about 50% and 80%, more preferably between about 55% and 75%, or even more preferably between about 60% and 70%, by weight of the first component.

The silane modified epoxy resin may be present in an amount of between about 0.5% and 10%, more preferably between about 1% and 9%, or even more preferably between about 2% and 8%, by weight of the first component. The silane modified epoxy resin may be present in an amount of about 0.5% or more, 1% or more, 2% or more, or even 3% or more, by weight of the first component. The silane modified epoxy resin may be present in an amount of about 10% or less, 9% or less, 8% or less, or even 7% or less, by weight of the first component. The silane modified epoxy resin may have an epoxy equivalent weight of about 170 g/eq to 240 g/eq, preferably about 180 g/eq to 230 g/eq, or even about 190 g/eq to 220 g/eq, according to ASTM D1652-11. The silane modified epoxy resin may have a viscosity, measured at 25° C., of about 7,000 cP to 17,000 cP, preferably about 8,000 cP to 16,000 cP, or even about 9,000 cP to 15,000 cP.

The epoxy novolac resin may include one or more liquid epoxy novolac resins, one or more solid epoxy novolac resins, or both. The epoxy novolac resin may have a functionality of about 2 to 7. The one or more epoxy novolac resins may be present in an amount of about 10% or more, 15% or more, 20% or more, or even 25% or more, by weight of the first component. The one or more epoxy novolac resins may be present in an amount of about 60% or less, 50% or less, 40% or less, or even 30% or less, by weight of the first component.

The epoxy novolac resin may be solid and may have an epoxy equivalent weight of about 175 g/eq to 250 g/eq, preferably about 185 g/eq to 240 g/eq, or even about 195 g/eq to 230 g/eq, according to ASTM D1652-11. The epoxy novolac resin may be solid and may have a viscosity, measured at 25° C., of about 1 P to 80 P, preferably about 5 P to 70 P, or even about 10 P to 60 P, according to ASTM D445-21.

The epoxy novolac resin may be liquid and may have an average functionality of about 1.5 to 4, more preferably 2 to 3.5, more preferably about 2.5 to 3, or even about 2.65. The epoxy novolac resin may be liquid and may have an epoxy equivalent weight of about 130 g/eq to 200 g/eq, preferably about 145 g/eq to 185 g/eq, or even about 165 g/eq to 178 g/eq, according to ASTM D1652-11. The epoxy novolac resin may be liquid and may have an epoxy equivalent weight of about 145 g/eq to 195 g/eq, more preferably 155 g/eq to 185 g/eq, or even more preferably 164 g/eq to 177 g/eq, according to ASTM D1652-11. The epoxy novolac resin may be liquid and may have a viscosity, measured at 25° C., of about 10,000 cP to 40,000 cP, preferably about 15,000 cP to 30,000 cP, or even about 18,000 cP to 28,000 cP, according to ASTM D445-21. The epoxy novolac resin may be liquid and has a viscosity, measured at 25° C., of about 16,000 cP to 25,000 cP, preferably 17,000 cP to 24,000 cP, or even 18,000 cP to 23,000 cP, according to ASTM D445-21.

The first component may comprise one or more additives; and wherein the one or more additives include one or more metal carbonates, minerals, reinforcing fibers, hydrophobic silica, core-shell particulate polymers, or any combination thereof. The metal carbonate may include an ultra-fine calcium carbonate (e.g., particle size about 1 to 3 micron), a fine calcium carbonate, a medium-fine calcium carbonate (e.g., particle size about 10 to 24 micron), a coarse calcium carbonate (e.g., particle size about 200 to 800 microns), or any combination thereof.

The two-part system, after mixing the first component and the second component, may foam to an increased volume of between about 10% and 800%, more preferably between about 50% and 700%, or even more preferably between about 100% and 600% of the original unexpanded volume of the first component and the second component.

The one or more acids may comprise at least one or more phosphate esters, and optionally phosphoric acid, polyphosphoric acid, phosphorous acid, other phosphorous compounds, citric acid, acetic acid, any acid that is stable with phosphoric acid or phosphate ester, or any combination thereof.

The one or more phosphate esters may be reaction products of a mono-epoxide with phosphoric acid; preferably selected from mono-esters, di-esters, and tri-esters. The one or more phosphate esters may include cashew nut shell liquid-based phosphate esters, 2-ethylhexyl glycidyl ether-based phosphate esters, phenyl glycidyl ether-based phosphate esters, or any combination thereof.

The cashew nut shell liquid-based phosphate esters are a reaction product of epoxidized cashew nut shell liquid and phosphoric acid; preferably mono-esters. The 2-ethylhexyl glycidyl ether-based phosphate esters may be a reaction product or isomer of a reaction product of 2- ethylhexyl glycidyl ether and phosphoric acid. The phosphate ester is present in the second component in an amount of between about 40% and 95%, more preferably between about 50% and 80%, or even more preferably between about 60% and 70%, by weight of the second component.

The optional phosphoric acid, polyphosphoric acid, phosphorous acid, other acidic phosphorous compounds, citric acid, acetic acid, any acid that is stable with phosphoric acid or phosphate ester, or any combination thereof may be present in the second component in an amount of between about 4% and 18%, more preferably between about 6% and 16%, or even more preferably between about 8% and 14%, by weight of the second component.

The weight ratio of phosphate ester to fire resistance improving additives may be between about 2.5:1 and 9:1, preferably between about 3:1 and 8.5:1, or even between about 3.3:1 and 4.6:1. the weight ratio of phosphoric acid, polyphosphoric acid, phosphorous acid, other phosphorous compounds, citric acid, acetic acid, any acid that is stable with phosphoric acid or phosphate ester, or any combination thereof to the fire resistance improving additives may be between about 2:1 and 1:10, preferably between about 1:1 and 1:8, or even between about 1:2 and 1:4.

The second component may comprise one or more other fire resistance improving additives that are stable with the one or more acids. The second component may comprise one or more additives. The one or more additives may include one or more minerals, reinforcing fibers, hydrophobic silica, core-shell particulate polymers, glass microspheres, or any combination thereof.

The two-part system may be a thermoset. The two-part system may cure at room temperature.

The teachings herein further contemplate a composition comprising a first component comprising one or more epoxy resins and one or more fire resistance improving additives, and a second component comprising one or more curatives selected from acids and acid esters. The fire resistance improving additives are selected from ammonium polyphosphate, organic phosphinate, or some combination thereof.

The teachings herein are further directed to the use of a fire-resistant two-part system according to any of the preceding claims as a fire-resistant material, an adhesive, a composite material matrix resin, a structural foam, a cavity filler, a structural reinforcement, a sealing material, or any combination thereof. Such use may be for automotive, aerospace, construction, repair shop, home maintenance, or any combination thereof

The one or more fire resistance improving additives may include a phosphorous-based material, a metal hydroxide, or both. The phosphorous-based material may include 9,10-Dihydro-9-oxa-10-phosphaphenanthrene 10-oxide, an ammonium polyphosphate, an organic phosphinate, or any combination thereof. The metal hydroxide may include aluminum hydroxide, magnesium hydroxide, or both. The one or more fire resistance improving additives may be present in the first component in an amount of between about 0.5% and 30%, more preferably about 5% to 25%, or even more preferably about 10% to 20%, by weight of the first component.

The first component may comprise one or more epoxy resins including one or more multifunctional aromatic epoxy resins, multifunctional aliphatic epoxy resins, epoxy novolac resins, silane modified epoxy resins, or any combination thereof. The one or more epoxy resins may be present in an amount of between about 50% and 80%, more preferably between about 55% and 75%, or even more preferably between about 60% and 70%, by weight of the first component. The silane modified epoxy resin is present in an amount of between about 0.5% and 10%, more preferably between about 1% and 9%, or even more preferably between about 2% and 8%, by weight of the first component. The epoxy novolac resin may include one or more liquid epoxy novolac resins, one or more solid epoxy novolac resins, or both.

The first component may comprise one or more additives. The one or more additives may include one or more metal carbonates, minerals, reinforcing fibers, hydrophobic silica, core-shell particulate polymers, or any combination thereof.

The metal carbonate may include an ultra-fine calcium carbonate, a fine calcium carbonate, a medium-fine calcium carbonate, a medium calcium carbonate, a coarse calcium carbonate, or any combination thereof. The two-part system, after mixing the first component and the second component, may foam to an increased volume of between about 10% and 800%, more preferably between about 50% and 700%, or even more preferably between about 100% and 600% of the original unexpanded volume of the first component and the second component.

The first component or even the second component may consist essentially of the fire resistance improving additives.

The one or more acids may comprise at least one or more phosphate esters, and optionally phosphoric acid, citric acid, acetic acid, other acidic phosphorous compounds, any acid that is stable with phosphoric acid or phosphate ester, or any combination thereof. The one or more phosphate esters may include cashew nut shell liquid-based phosphate esters, 2-ethylhexyl glycidyl ether-based phosphate esters, phenyl glycidyl ether-based phosphate esters, or any combination thereof. The phosphate ester may be present in the second component in an amount of between about 40% and 95%, more preferably between about 50% and 80%, or even more preferably between about 60% and 70%, by weight of the second component. The optional phosphoric acid, citric acid, acetic acid, other acidic phosphorous compounds, any acid that is stable with phosphoric acid or phosphate ester, or any combination thereof may be present in the second component in an amount of between about 4% and 18%, more preferably between about 6% and 16%, or even more preferably between about 8% and 14%, by weight of the second component.

The second component may comprise one or more other fire resistance improving additives that are stable with the one or more acids.

A ratio of the acidic component to fire resistance improving additives may be between about 2:1 and 1:10, more preferably between about 1:1 and 1:8, or even more preferably between about 1:2 and 1:4.

The second component may comprise one or more additives. The one or more additives may include one or more minerals, reinforcing fibers, hydrophobic silica, core-shell particulate polymers, glass microspheres, or any combination thereof.

The two-part system may be a thermoset.

The two-part system may cure at a temperature of between about 0° C. and 60° C. The two-part system may cure at room temperature (i.e., between about 20° C. and 25° C.).

### DETAILED DESCRIPTION

The present teachings meet one or more of the above needs by the improved two-part system described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the below description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the priority date of U.S. Provisional Application Ser. No. 63/244,347, filed on Sep. 15, 2021. The contents of that application are incorporated by reference herein in their entirety for all purposes.

International Publication Nos. WO 2020/101732 A1, WO 2020/205355 A1, WO 2020/206346 A1, and WO 2020/198139 A1 illustrate the use of phosphoric acid and phosphate esters for cure-in-place compositions. These compositions are typically employed for a wide range of room-temperature activated systems, such as rigid structural foams, cavity filling, gaskets, and sealants. The benefits of such compositions may include the ability to adhere to a variety of substrates, the inclusion of low volatility organic compounds (VOC's), not being sensitive to the dispensing temperature, not being sensitive to the exact mixing ratio of a two-part system, the ability to tune physical and/or mechanical properties, or any combination thereof.

These compositions may be fire resistant in the absence of any fire resistance improving additives. Without intending to be bound by theory, the fire resistance may result from the acid component in the composition, as disclosed herein. More specifically, the elemental phosphorous in the acid that then becomes part of cured composition may contribute to fire resistance. The acid component may be referred to herein alternatively as the curative. The inclusion of fire resistance improving additives may improve the already-present fire-resistant properties of the material. The two-part system may employ one or more fire resistance improving additives in an amount of about 30% or less, 25% or less, 20% or less, or even 15% or less, by weight. Inclusion of fire resistance improving additives in these quantities may provide the material with similar or even better fire resistance properties compared to other materials that are devoid of the acid component (e.g., phosphate ester or phosphoric acid), as disclosed herein.

As a comparison, other types of polymeric materials that are devoid of an acid component and employed for similar applications may need a large quantity of fire resistance improving additives (e.g., about 40% or more, 50% or more, or even 60% or more, by weight) to achieve their desired fire resistance performance. These polymeric materials may, for example, be epoxy-based and/or polyurethane-based, but any polymeric material system may be employed. However, fire resistance improving additives may negatively impact the physical and mechanical properties of the material by replacing polymeric matrix with particulate matter. This consequence may be enhanced when large quantities of fire resistance improving additives (e.g., about 40% or more, 50% or more, or even 60% or more, by weight) are included. Thus, the composition of the present disclosure may enjoy the benefit of meeting or exceeding fire resistance performance of the aforementioned compositions while employing an amount of fire resistance improving additives that does not or at least does not appreciably (i.e., by about 10%, more preferably 5%, or even more preferably 1%) diminish the physical and/or mechanical properties thereof.

The composition of the present teachings may be a two-part composition (“two-part system”). The two-part system may comprise an A-side, alternatively referred to herein as a first component, and a B-side, alternatively referred to herein as a second component. The A-side and the B-side may be mixed to form a mixed composition. The mixed composition may cure to form a reaction product. The reaction product may be completely cured (i.e., undergoing no further cross-linking reactions). Curing may initiate after mixing the A-side and the B-side. Curing may initiate generally immediately upon mixing the A-side and the B-side. Curing may be delayed for a time after mixing the A-side and the B-side. The two-part system may be free of latent curing agents, curing accelerators, or both.

The two-part system may be mixed at a temperature of between about 0° C. to 60° C. Curing of the two-part system may activate at room temperature. The two-part system may optionally volumetrically expand (foam). Volume expansion, if desired, may increase by increasing the temperature the mixed composition is exposed to. Ambient temperature may not affect foaming rate as much as the temperature of the two-part system at the time of dispensing.

The two-part system may form a thermoset.

The two-part system may be employed in automotive, aerospace, construction, repair shop, home maintenance, other similar industries, or any combination thereof. The two-part system may be employed as a fire-resistant material. The two-part system may be employed as an adhesive, a composite material matrix resin, a structural foam, a cavity filler, a structural reinforcement, a sealing material, or any combination thereof. The adhesive may adhere similar and/or dissimilar substrates.

The two-part composition system of the present teachings may be dispensed. The dispensing may be performed by dispensing equipment. The dispensing may be performed by automated or non-automated dispensing equipment. The dispensing may be performed by pneumatic or manual systems. The two-part composition may be mixed manually, without using a cartridge or dispensing equipment. The manually mixed two-part composition may be poured on a substrate or in a cavity.

### A-Side (“First Component”)

The A-side may comprise one or more epoxy resins, (i.e., chemical compositions with one or more reactive epoxide groups), fire resistance improving additives, reactive diluents, or any combination thereof. The A-side may optionally comprise one or more reactive diluents. One or more or even two or more different fire resistance improving additives may be employed in the composition of the present disclosure. Different fire resistance improving additives may provide different modes of fire resistance. That is, the different fire resistance improving additives may function differently in response to exposure to an ignition source. As referred to herein, ignition source may mean open flame, sparks, extreme temperatures, or any combination thereof.

Extreme temperatures, as referred to herein, may mean the autoignition temperature of the material. Extreme temperatures, in context of the present disclosure, may be about 400° C. or more, 500° C. or more, 600°° C. or more, or even 700° C. or more. Extreme temperatures, in context of the present disclosure may be about 1,100° C. or less, 1,000° C. or less, 900° C. or less, or even 800° C. or less.

At least four different modes of fire resistance may include barrier generation, energy reduction, polymer chain incorporation, and oxidation inhibition.

Some fire resistance improving additives and/or their degradation products may generate a barrier. When a material containing these fire-resistance-improving additives is exposed to an ignition source, the surface, in a condensed phase (i.e., solid or liquid), thereof may char. The barrier may be a poor conductor of heat. The barrier may prevent heat transfer into the depth of the material. The barrier may inhibit the migration of gaseous material, originating from the condensed phase, into contact with ignition sources. The gaseous material may pose a risk of acting as a fuel.

Some fire resistance improving additives may reduce the energy of an ignition source. That is, degradation of these fire resistance improving additives in the condensed phase may involve an endothermic reaction. Heat imparted by ignition sources upon materials comprising these fire-resistance-improving additives may be absorbed by material undergoing the endothermic reactions.

Some fire resistance improving additives may be incorporated in the polymer chain. For instance, the fire resistance improving additives may locate between epoxy moieties. This may result from an acid component, as disclosed herein, reacting with the fire resistance improving additives. The acid may originate from the B-side of the two-part system of the present disclosure. The performance of the fire resistance improving additives could be improved when added and attached to the polymeric chain through covalent bonding.

Some fire resistance improving additives may, in the gaseous phase, inhibit oxidation reactions that may occur in ignition sources. This may be achieved by at least two mechanisms. First, the fire resistance improving additives and/or their degradation products may enter the gaseous phase in sufficient amount to dilute fuel supplied to a fire. At least some of the fuel may be produced by pyrolysis of polymer (e.g., epoxy) and migration of the same from the condensed phase to the gaseous phase. Second, the fire resistance improving additives and/or their degradation products may inhibit radical mechanisms that would otherwise contribute to exothermic processes to generate heat. The fire resistance improving additives may degrade by pyrolysis and emit from the condensed phase into the gaseous phase.

Two or more of these modes of fire resistance may act synergistically in the composition of the present disclosure. As a result, low quantities (e.g., about 30% or less, 20% or less, or even 10% or less, by weight of the A-side) of fire resistance improving additives may be employed to provide the composition with fire resistance performance that at least equals but preferably exceeds the fire resistance performance of other types of compositions that do not employ the acid component of the present disclosure. These other types of compositions may employ large quantities of fire resistance improving additives (e.g., about 40% or more, 50% or more, or even 60% or more, by weight) to achieve their desired fire resistance performances.

Fire resistant materials may decrease the risk of fires starting. In the case of an already started fire, the fire-resistant materials may decrease the risk of the fire spreading. Fire resistance may be imparted or increased in a material by the addition of fire resistance improving additives. fire resistance improving additives may slow or even stop the combustion cycle. The combustion cycle, as referred to herein, may mean one or any combination of the following: provision of an ignition source, degradation of materials by pyrolysis, emission of degraded materials into the gaseous phase, charring of materials, combustion of flammables in the gaseous phase, provision of oxygen to an ignition source, exothermic radical chain reactions, emission of byproducts (e.g., H₂O, CO₂), or any combination thereof.

The inclusion of fire resistance improving additives in compositions may negatively impact physical properties, especially in larger amounts (e.g., about 40% or more, by weight of the A-side).

Fire resistance improving additives, particularly the types taught herein, may react with some polymer curatives. Two-part systems may have a prolonged shelf life due to the separation of reactive components from fire resistance improving additives during storage and transportation. However, materials that include large quantities (e.g., about 40% or more, by weight of the A-side) of fire resistance improving additives typically must allocate some of the fire resistance improving additives in each part, at least in part due to the increase of viscosity directly correlated to the amount of fire resistance improving additives. The increase in viscosity, if all fire resistance improving additives is allocated to just one part, may inhibit proper dispensing and mixing. Thus, shelf life suffers as reactive species are exposed to each other. The acid (e.g., phosphate ester) of the present disclosure may not react with the fire resistance improving additives disclosed herein. The shelf life of the two-part system of the present teachings may be improved compared to materials comprising large quantities of fire resistance improving additives (e.g., about 40% or more, by weight of the A-side, and possibly 40% or more, by weight of the B-side). The shelf life of the two-part system of the present teachings may be about 3 months or more, more preferably about 6 months or more, more preferably about 12 months or more, or even more preferably about 24 months or more.

The small ratio of fire resistance improving additives in the two-part system may result in a lower viscosity, as compared to materials comprising large quantities of fire resistance improving additives (e.g., about 40% or more, by weight of the A-side). The relatively lower viscosity may provide for easier application, proper mixing, and proper dispensing, of the two-part system. The relatively lower viscosity may provide for easier access to narrow regions and/or complex cavities.

The fire resistance improving additives could also have various advantages whether or not they react in the system.

The fire resistance improving additives may include phosphorous-containing materials and inorganics. Both may be used to provide a synergistic effect. The fire resistance improving additives may be provided in the form of a solid powder.

The fire resistance improving additives may be present in an amount of about 30% or less, 20% or less, or even 10% or less, by weight of the A-side.

Phosphorus-containing fire resistance improving additives may pyrolyze to form a polyphosphoric acid char barrier. The barrier may be thermally stable. The barrier may slow the pyrolysis step in a combustion cycle. Phosphorous-containing fire resistance improving additives may pyrolyze to form non-flammable inert gasses. The gasses may include water vapor. The gasses may dilute fuel that otherwise may be consumed by fire and/or inhibit radical reaction systems.

The phosphorous-containing fire resistance improving additives may be free of halogens. The phosphorous-containing fire resistance improving additives may be non-toxic. That is, upon pyrolysis, the byproducts delivered to the gaseous phase may be non-toxic.

The phosphorous-containing fire resistance improving additives may include 9,10-Dihydro-9-oxa-10-phosphaphenanthrene 10-oxide, ammonium polyphosphate, organic phosphinate, or any combination thereof.

The phosphorous-containing fire resistance improving additives may include 9,10-Dihydro-9-oxa-10-phosphaphenanthrene 10-oxide (“DOPO”), as shown below.

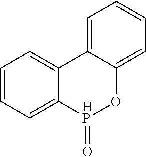

A non-limiting example of a suitable fire resistance improving additives may be GOYENCHEM-DOPO, commercially available from Go Yen Chemical Industrial Co., Ltd.

The phosphorous-containing fire resistance improving additives may include ammonium polyphosphate, as shown below.

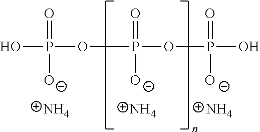

The ammonium polyphosphate may be linear or branched. The ammonium phosphate may be short—(i.e., n<1000) linear chained or long—(i.e., n>1000) branched chained.

The ammonium polyphosphate may function as an intumescent. That is, the ammonium polyphosphate may swell in response to heat exposure resulting in an increase in volume and a decrease in density. The ammonium polyphosphate may produce a char, upon exposure to an ignition source, that is a poor conductor of heat. The ammonium polyphosphate may undergo an endothermic reaction upon heat exposure. The ammonium polyphosphate may include water in the form of hydrates. Both the endothermic reaction and presence of water may contribute to fire resistance.

The ammonium polyphosphate may be present in an amount of about 3% or more, 7% or more, or even 11% or more, by weight of the A-side. The ammonium polyphosphate may be present in an amount of about 25% or less, 19% or less, or even 15% or less, by weight of the A-side.

A non-limiting example of a suitable fire resistance improving additives may be GOYENCHEM-OP901, commercially available from Go Yen Chemical Industrial Co., Ltd. The fire resistance improving additives may be an organic phosphinate, as shown below.

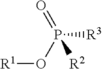

The organic phosphinate may function to decompose when heated and releases diethyl phosphinic acid in the gas phase as discussed in Macromol. Mater. Eng. 2008, 293, 206-217, incorporated herein by reference in its entirety for all purposes.

The fire resistance improving additives may have a particle size of about 20 microns or less, 10 microns or less, or even 5 microns or less. The fire resistance improving additives may have a phosphorous content of between about 15% and 35%, more preferably between about 20% and 30%, or even more preferably between about 23% and 25% w/w.

A non-limiting example of a suitable fire resistance improving additives may be the organic phosphinate Exolit® OP 935, commercially available from Clariant.

The organic phosphinate may be present in an amount of about 0.5% or more, 1% or more, or even 3% or more, by weight of the A-side. The organic phosphinate may be present in an amount of about 9% or less, 7% or less, or even 5% or less, by weight of the A-side. Generally, the fire resistance may increase with an increasing amount of organic phosphinate.

The fire resistance improving additives may include a metal hydroxide. The fire resistance improving additives may include aluminum hydroxide. Inorganic fire resistance improving additives may decompose in presence of open flame or excess heat, release water and/or non-flammable gases, and ultimately dilute the combustible gases. This may reduce the fuel accessible to open flame and make a barrier layer on the surface of the material, which may slow and ultimately stop the fire. The metal hydroxide may have an ultra-fine particle size. The metal hydroxide may have a particle size of about 10 microns or less, 5 microns or less, or even 1 micron or less. A non-limiting example of a suitable aluminum hydroxide may be Micral® AM550, commercially available from J. M. Huber Corporation.

The A-side may include one or more epoxy resins. The epoxy resins may include multifunctional aromatic epoxy resins, multifunctional aliphatic epoxy resins, silane modified epoxy resins, epoxy/elastomer adducts, or any combination thereof.

The epoxy resin may be present in the A-side in an amount of about 50% or more, 55% or more, or even 60% or more, by weight of the A-side. The epoxy resin may be present in the A-side in an amount of about 80% or less, 75% or less, or even 70% or less, by weight of the A-side.

Providing the A-side with one or more epoxy resins may delay the reaction time and therefore increase the working time of the composition.

The two-part system may include one or more multifunctional aromatic and/or aliphatic epoxy resins. The multifunctional aromatic and/or aliphatic epoxy resins may increase the crosslink density of the reaction product, improve mechanical properties of the reaction product, improve chemical resistance of the reaction product, reduce the viscosity of the two-part system and/or mixed composition, improve the cell structure quality of a foamed reaction product, or any combination thereof. The functionality of the multifunctional aromatic and/or aliphatic resin may be about 2 or more, 3 or more, or even 4 or more. The functionality of the multifunctional aromatic and/or aliphatic resin may be about 8 or less, 7 or less, or even 6 or less.

The A-side may comprise one or more metal carbonates, where foaming is desired. Where the two-part system includes metal carbonate in the A-side, effective functionality of the B-side may be partially reduced in the mixed composition. This may be due to reaction of the acid of the B-side with the metal carbonates of the A-side to cause foaming. The A-side may include components with increased functionality to compensate for a reduced functionality of the B-side as a result of the metal carbonate reaction. The A-side may be formulated with increased functionality by using reactive ingredients with functionality higher than 2 such as aliphatic multifunctional epoxy resins.

Examples of suitable multifunctional resins may include, but are not limited to, epoxidized sorbitol, epoxidized soybean oil, solid epoxy novolac resins, liquid epoxy novolac resins, or any combination thereof.

The multifunctional aliphatic epoxy resin may have an epoxy equivalent weight of about 130 g/eq to 230 g/eq, more preferably about 140 g/eq to 220 g/eq, or even more preferably about 160 g/eq to 195 g/eq, according to ASTM D1652-11. The multifunctional aliphatic epoxy resin may have a viscosity, measured at 25° C., of about 6,000 cP to about 20,000 cP, more preferably about 7,000 cP to 19,000 cP, or even more preferably about 8,000 cP to 18,000 cP, according to ASTM D445-21. The multifunctional aliphatic epoxy resin may include an epoxidized sorbitol. A non-limiting example of a suitable multifunctional aliphatic epoxy resin may include Erisys® GE 60, commercially available from Huntsman Advanced Materials.

The multifunctional aliphatic epoxy resin may be a reaction product of epichlorohydrin and propylene glycol. The multifunctional aliphatic epoxy resin may be a liquid epoxy resin. The multifunctional aliphatic epoxy resin may have an epoxy equivalent weight of about 290 g/eq to 360 g/eq, more preferably about 300 g/eq to 350 g/eq, or even more preferably about 310 g/eq to 340 g/eq, according to ASTM D1652-11. The multifunctional aliphatic epoxy resin may have a viscosity, measured at 25° C., of about 40 cP to 90 cP, more preferably about 50 cP to 80 cP, or even more preferably about 60 cP to 70 cP, according to ASTM D445-21. A non-limiting example of a suitable multifunctional aliphatic epoxy resin may be D.E.R.™ 732, commercially available from Dow.

The multifunctional aromatic epoxy resin may include a reaction product of epichlorohydrin and bisphenol A. The epoxy resin may be a liquid epoxy resin. The epoxy resin may have an epoxy equivalent weight of about 160 g/eq to 210 g/eq, more preferably about 170 g/eq to 200 g/eq, or even more preferably about 182 g/eq to 192 g/eq, according to ASTM D1652-11. The epoxy resin may have a viscosity, measured at 25° C., of about 9,000 cP to 16,000 cP, more preferably about 10,000 cP to 15,000 cP, or even more preferably about 11,000 cP to 14,000 cP, according to ASTM D445-21. A non-limiting example of a suitable difunctional aromatic epoxy resin may include D.E.R.™ 331™, commercially available from Olin.

The multifunctional aromatic epoxy resin may include a reaction product of epichlorohydrin and bisphenol F. The epoxy resin may be a liquid epoxy resin. The epoxy resin may have an epoxy equivalent weight of about 145 g/eq to 195 g/eq, more preferably about 155 g/eq to 185 g/eq, or even more preferably about 165 g/eq to 175 g/eq, according to ASTM D1652-11. The epoxy resin may have a viscosity, measured at 25° C., of about 1,000 cP to 7,000 cP, more preferably about 2,000 cP to 6,000 cP, or even more preferably about 3,000 cP to 5,000 cP, according to ASTM D445-21. A non-limiting example of a suitable multifunctional aromatic epoxy resin may include Epotec® YDF 172 LV, commercially available from Aditya Birla Chemicals.

The two-part system may include one or more epoxy novolac resins. The epoxy novolac resin may be liquid or solid at room temperature. The two-part system may include one or more liquid epoxy novolac resins, one or more solid epoxy novolac resins, or both. The epoxy novolac resin may have a functionality of about 2 to 7. The epoxy novolac resin may function to improve crosslink density, improve glass transition temperature, improve mechanical properties, improve chemical resistance, improve moisture resistance, or any combination thereof of the reaction product. Increasing the crosslink density may increase the fire resistance of the cured composition. Greater amounts of epoxy novolac resins could be used to improve the stiffness (i.e., elastic modulus) of the composition. Greater amounts of epoxy novolac resins could be used to compensate for a reduced stiffness of the composition resulting from the inclusion of fire resistance improving additives. Selection of epoxy novolac resin may depend on the desired viscosity, mechanical properties, and chemical resistance for the reaction product.

The one or more epoxy novolac resins may be present in an amount of about 10% or more, 15% or more, 20% or more, or even 25% or more, by weight of the A-side. The one or more epoxy novolac resins may be present in an amount of about 60% or less, 50% or less, 40% or less, or even 30% or less, by weight of the A-side.

The polymeric solid epoxy novolac resin may have an epoxy equivalent weight of about 175 g/eq to 250 g/eq, more preferably about 185 g/eq to 240 g/eq, or even more preferably about 195 g/eq to 230 g/eq, according to ASTM D1652-11. The polymeric solid epoxy novolac resin may have a viscosity, measured at 25° C., of about 1 P to 80 P, more preferably about 5 P to 70 P, or even more preferably about 10 P to 60 P, according to ASTM D445-21. A non-limiting example of a suitable polymeric solid epoxy novolac resin may include Epon™ SU-8, commercially available from Hexion.

The liquid epoxy novolac resin may have an average functionality of about 1.5 to 4, more preferably 2 to 3.5, more preferably about 2.5 to 3, or even more preferably about 2.65. The liquid epoxy novolac resin may have an epoxy equivalent weight of about 130 g/eq to 200 g/eq, more preferably about 145 g/eq to 185 g/eq, or even more preferably about 165 g/eq to 178 g/eq, according to ASTM D1652-11. The liquid epoxy novolac resin may have a viscosity, measured at 25° C., of about 10,000 cP to 40,000 cP, more preferably about 15,000 cP to 30,000 cP, or even more preferably about 18,000 cP to 28,000 cP, according to ASTM D445-21. A non-limiting example of a suitable liquid epoxy novolac resin may include Epalloy® 8250, commercially available from Huntsman Advanced Materials.

The liquid epoxy novolac resin may be a reaction product of epichlorohydrin and phenol-formaldehyde novolac. The epoxy phenol novolac resin may have an epoxy equivalent weight of about 145 g/eq to 195 g/eq, more preferably 155 g/eq to 185 g/eq, or even more preferably 164 g/eq to 177 g/eq, according to ASTM D1652-11. The epoxy phenol novolac resin may have a viscosity, measured at 25° C., of about 16,000 cP to 25,000 cP, more preferably 17,000 cP to 24,000 cP, or even more preferably 18,000 cP to 23,000 cP, according to ASTM D445-21. A non-limiting example of a suitable liquid epoxy novolac resin may include D.E.N.™ 426, commercially available from Olin Epoxy.

The two-part system may include one or more silane modified epoxy resins. The silane modified epoxy resin may function to impart improved adhesion of the reaction product. The adhesion may be to glass, metal, or both. The silane groups may form covalent bonds with epoxy resins and inorganic substrates. The silane modified epoxy resin may be present in the A-side. The silane modified epoxy resin may be present in an amount of about 0.5% or more, 1% or more, 2% or more, or even 3% or more, by weight of the A-side. The silane modified epoxy resin may be present in an amount of about 10% or less, 9% or less, 8% or less, or even 7% or less, by weight of the A-side.

The silane modified epoxy resin may have an epoxy equivalent weight of about 170 g/eq to 240 g/eq, more preferably about 180 g/eq to 230 g/eq, or even more preferably about 190 g/eq to 220 g/eq, according to ASTM D1652-11. The silane modified epoxy resin may have a viscosity, measured at 25° C., of about 7,000 cP to 17,000 cP, more preferably about 8,000 cP to 16,000 cP, or even more preferably about 9,000 cP to 15,000 cP. A non-limiting example of a suitable silane modified epoxy resin may include Epokukdo KSR 177, commercially available from Kukdo Chemical Co., Ltd.

The two-part system may include one or more epoxy/elastomer adducts. The epoxy/elastomer adduct may be included to impart a plasticization effect to the two-part system; and/or modify structural properties of the two-part system such as strength, strain-to-failure, fracture toughness (G1c), peel, adhesion durability, uncured-material integrity (i.e., less likely to stick, break or deform before use), and stiffness. Carboxyl-terminated butadiene-acrylonitrile may be particularly useful for developing adhesion to contaminated surfaces. The contaminated surfaces may include stamping lubricants typical to the automotive industry.

The elastomer in the adduct may be selected from polysulfide, polybutadiene, polyisoprene, polyisobutylene, isoprene-butadiene copolymer, neoprene, acrylic, natural rubber, carboxyl-terminated butadiene-acrylonitrile, polysiloxane, polyester, urethane prepolymer, nitrile rubber (e.g., a butyl nitrile, such as carboxy-terminated butyl nitrile), butyl rubber, polysulfide elastomer, acrylic elastomer, acrylonitrile elastomers, silicone rubber, polyester rubber, diisocyanate-linked condensation elastomer, styrene butadiene rubber, ethylene-propylene diene rubbers, chlorosulfonated polyethylene, fluorinated hydrocarbons, or any combination thereof. The epoxy/elastomer adduct may include a carboxyl-terminated polymer (e.g., an adducted carboxyl-terminated polymer, an adducted carboxy-terminated butyl nitrile). The epoxy/elastomer adduct may be a dicarboxylic acid. The elastomer compound suitable for the adduct may be a thermosetting elastomer, although not required.

Examples of or alternative epoxy/elastomer or other adducts suitable for use in the present teachings are disclosed in United States Patent Publication No. 2004/0204551 A1 and International Publication No. 2020/033393 A1. The A-side may include one or more additives. The one or more additives may include metal carbonates, minerals, reinforcing fibers, hydrophobic silica, core-shell particulate particles, or any combination thereof.

The two-part system may foam due to the presence of one or more metal carbonates in the two-part system. The metal carbonate may react with an acid. The metal carbonate may be provided in the A-side. The acid may be provided in the B-side. The metal carbonate may include a calcium carbonate.

The metal carbonate may be provided as a combination of fine and a medium-fine size calcium carbonate. The fine calcium carbonate may provide a uniform and fine cell structure. The combination of fine and medium-fine size calcium carbonates may provide a balance between the foaming and curing and thus structural integrity of the foam.

The reaction product may have a volume expansion of about 10% or more, 50% or more, 100% or more, or even 200% or more. The reaction product may have a volume expansion of about 800% or less, 700% or less, 600% or less, or even 500% or less.

Foaming may begin before complete cure of the reaction product. The foaming time of the mixed composition may be about 30 seconds or more, 1 minute or more 5 minutes or more, or even 10 minutes or more. The foaming time of the mixed composition may be about 2 hours or less, 1 hour or less, or even 30 minutes or less. The foaming time may be the time frame within which the two-part system actively foams.

The calcium carbonate may include an ultra-fine particle size calcium carbonate. The ultra-fine particle size may be about 1 micron to 3 micron, or even more preferably about 2 microns. A non-limiting example of a suitable ultra-fine calcium carbonate may include Hubercarb® Q2, commercially available from Huber Engineered Materials.

The calcium carbonate may include a medium fine particle size calcium carbonate. The medium fine particle size may be about 20 microns to 24 microns, or even more preferably about 22 microns. A non-limiting example of a suitable medium fine particle size calcium carbonate may include Hubercarb® Q200, medium fine, commercially available from Huber Engineered Materials. The medium fine particle size may be about 10 microns to 16 microns, or even more preferably about 13 microns. A non-limiting example of a suitable ultra-fine calcium carbonate may include Hubercarb® Q325, commercially available from Huber Engineered Materials.

The calcium carbonate may include a coarse particle size calcium carbonate. The coarse particle size may be about 200 microns to 800 microns, 300 microns to 700 microns, or even 400 microns to 600 microns. A non-limiting example of a suitable ultra-fine calcium carbonate may include Hubercarb® Q40-200, commercially available from Huber Engineered Materials.

The mineral may include one or more silicate minerals. The silicate mineral may include one or more inosilicates. The inosilicate may include wollastonite. Wollastonite may improve mechanical strength, durability, adhesion, moisture resistance, impact resistance, or any combination thereof. The external shape of an individual crystal or crystal group of the one or more minerals may be acicular. The acicular structure of the mineral with aspect ratios in the range of 9 to 20 may help to improve mechanical strength and durability of the reaction product. Non-limiting examples of suitable wollastonite may include NYGLOS® 12 and NYGLOS® 8, commercially available from NYCO Minerals Inc.; and Vansil® HR2000, commercially available from Vanderbilt Minerals, LLC.

Non-limiting examples of suitable hydrophobic silica may include AEROSIL® R 202 commercially available from Evonik Corporation; and CAB-O-SIL® TS-530 and TS-720, commercially available from Cabot Corporation.

An organophilic phyllosilicate may be used in place of a hydrophobic silica. An example of a suitable organophilic phyllosilicate may include Garamite-1958, commercially available from BYK-Chemie GmbH.

The two-part system may comprise one or more core-shell particulate polymers. The core-shell particulate polymer may function to improve the fracture toughness and ductility of the reaction product. Epoxy resin formulations are usually known for applications that require rigidity and high temperature resistance. Epoxies tend to be brittle. There are different strategies to reduce the brittleness of the epoxies. Often, tougheners such as core-shell polymers particles are used to reduce the brittleness and improve the fracture toughness of the reaction product without affecting the temperature resistance significantly.

The core-shell particulate polymer may be present in the A-side, B-side, or both. The core-shell particulate polymer may be present in an amount of about 5% or more, 10% or more, or even 15% or more, by weight of the A-side or B-side. The core-shell particulate polymer may be present in an amount of about 35% or less, 30% or less, or even 25% or less, by weight of the A-side or B-side.

The core-shell particulate polymer may be pre-blended with and dispersed in an epoxy resin. The core-shell particulate polymer may be dispersed in a bisphenol A-based epoxy resin. The epoxy resin may be a liquid epoxy resin. The epoxy resin may have a viscosity, measured at 50° C., of about 16,000 cP to about 20,000 cP, more preferably 17,000 cP to 19,000 cP, or even more preferably about 18,000 cP, according to ASTM D445-21. The core-shell particulate polymer may be present in the epoxy resin in an amount of about 30% to 45%, more preferably 35% to 40%, or even more preferably about 37%. The core-shell particulate polymer may have a median particle size of about 100 nm to 300 nm, or even about 200 nm. The core-shell particulate polymer may comprise polybutadiene. Non-limiting examples of suitable core-shell particulate polymers may include Kane Ace MX-257 and MX-267, commercially available from Kaneka Corporation.

### B-Side (“Second Component”)

The B-side may comprise one or more acids, acid anhydrides, epoxy resin reaction products, reactive diluents, additives, or any combination thereof. The reactive diluents and/or additives may be optional. The B-side may include one or more other fire resistance improving additives that are stable with the acids of the B-side. The B-side may consist essentially of one or more acids.

The B-side may comprise one or more acids. The acid may be liquid at room temperature. Room temperature, as referred to herein, may mean a temperature of between about 20° C. and 25° C. The acid may have a pH of less than 7. The acid may comprise phosphate ester, phosphoric acid, citric acid, acetic acid, other acidic phosphorous compounds, any acid that is stable with phosphoric acid or phosphate ester, or any combination thereof. The other acidic phosphorous compound may be represented by the following formula, wherein the X- and Y- may independently represent —OH, —OR, or any covalent moiety. R may represent any covalent moiety.

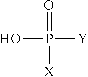

Non-limiting examples of another suitable acid phosphorous compound may include polyphosphoric acid and/or phosphorous acid.

The acid may comprise any suitable acid that is stable with and/or will not affect the shelf stability when mixed with phosphoric acid or phosphate ester. The acid may comprise at least phosphate ester and optionally phosphoric acid, citric acid, acetic acid, carboxylic acids, other acidic phosphorous compounds, any acid that is stable with phosphoric acid or phosphate ester, or any combination thereof.

The acid present in the B-side may enhance or provide fire resistance to the composition. Particularly, phosphoric acid and/or phosphate esters present in the B-side may provide fire resistance. Phosphorous containing fire resistance improving additives may produce a glassy layer of charred phosphoric acid. This layer may act as a barrier between fire and surfaces of the material susceptible to ignite. In addition to the chemical byproduct forming a barrier, the acid may produce a very high crosslink density when mixed with epoxy. The high crosslink density may provide favorable fire resistance.

The acid may contribute to foaming of the two-part system. That is, the acid may react with metal carbonates (e.g., calcium carbonate) present in the A-side.

The working time of the mixed composition may be tuned by the selection of the acid. Employing phosphate esters instead of phosphoric acid may delay the curing reaction, due to their higher pH, lower functionality, higher viscosity, or any combination thereof. The functionality and pH of phosphate esters may be selected to tune the working time.

The B-side may comprise one or more phosphate esters. The phosphate ester may be a reaction product of a mono-epoxide (“phosphate ester precursor”) with phosphoric acid, as shown below:

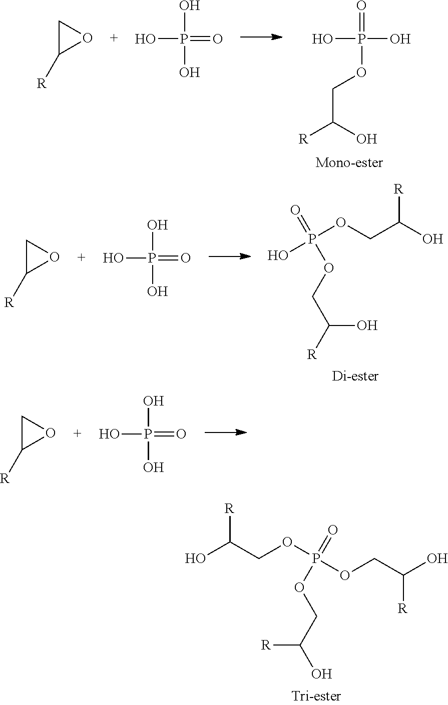

The phosphate esters may include a phosphate ester derived from cashew nut shell liquid (CNSL). The cashew nut shell liquid may be epoxidized. The epoxidized cashew nut shell liquid may be a reaction product of one or more components of cashew nut shell liquid and epichlorohydrin. The one or more components of cashew nut shell liquid may include anacardic acid, cardanol, cardol, or any combination thereof with an aliphatic C10-C20 moiety. The aliphatic C10-C20 moiety may be saturated or unsaturated. The aliphatic C10-C20 moiety may be hydrophobic. The phosphate ester may be a reaction product of epoxidized cashew nut shell liquid and phosphoric acid, as shown below:

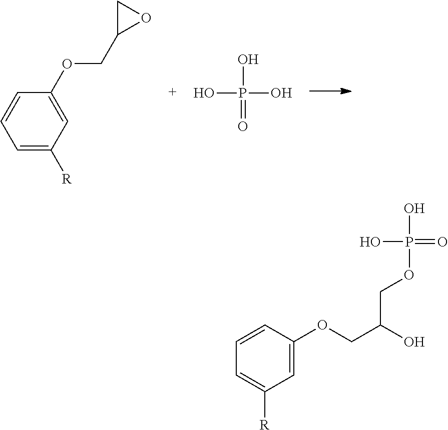

A cardanol-based cashew nut shell liquid is illustrated above but other components of cashew nut shell liquid are contemplated by the present disclosure. A non-limiting example of a suitable epoxidized cashew nut shell liquid may include Cardolite® LITE 2513HP, commercially available from Cardolite Corporation, Monmouth Junction NJ.

The phosphate esters may include a phosphate ester derived from 2-ethylhexyl glycidyl ether. The phosphate ester may be an isomer of a reaction product of 2-ethylhexyl glycidyl ether and phosphoric acid, as shown below:

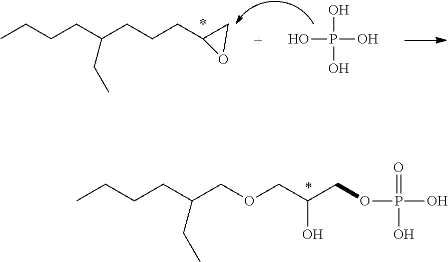

The above reaction may produce an isomer with the hydroxide group depending from the a carbon and an isomer with the hydroxide group depending from the β carbon.

A non-limiting example of a suitable 2-ethylhexyl glycidyl ether may include ERISYS® GE-6, commercially available from CVC Thermoset Specialties, Moorestown, NJ.

The phosphate esters may include a phosphate ester derived from phenyl glycidyl ether. A non-limiting example of a suitable phenyl glycidyl ether may include ERISYS® GE-13, commercially available from CVC Thermoset Specialties, Moorestown, NJ.

The phosphate esters may be produced by the reaction of phosphoric acid and various alcohols (“phosphate ester precursor”).

The B-side may comprise one or more phosphate esters, phosphate ester precursors, or both. The one or more phosphate esters may be pre-reacted. The B-side may comprise one or more phosphate ester precursors that may be combined with phosphoric acid prior to combination with the A-side.

The phosphate esters may be produced by a reaction of a range of stoichiometric ratios of phosphate ester precursors to phosphoric acid. The one or more phosphate esters may be produced by a reaction, in a ratio of phosphate ester precursor to phosphoric acid, of about 0.6:1 to 1:0.6, more preferably about 0.7:1 to 1:0.7, or even more preferably about 0.8:1 to 1:0.8. The phosphate ester may be present in an amount of about 40% or more, 50% or more, or even 60% or more, by weight of the B-side. The phosphate ester may be present in an amount of about 95% or less, 80% or less, or even 70% or less, by weight of the B-side.

The phosphoric acid, citric acid, acetic acid, other acidic phosphorous compounds, any acid that is stable with phosphoric acid or phosphate ester, or any combination thereof may be present in the B-side in an amount of about 4% or more, 6% or more, or even 8% or more, by weight of the B-side. The phosphoric acid, citric acid, acetic acid, other acidic phosphorous compounds, any acid that is stable with phosphoric acid or phosphate ester, or any combination thereof may be present in the B-side in an amount of about 18% or less, 16% or less, or even 14% or less, by weight of the B-side.

The B-side may include additional phosphoric acid. The additional phosphoric acid may include ortho-phosphoric acid, polyphosphoric acid, or both. The additional phosphoric acid may increase the crosslink density and reduce the open time. Reaction speed of the pre-reacted phosphate esters may be increased by the addition of the additional phosphoric acid in the B-side. The additional phosphoric acid may increase foaming speed and total volume of foaming of the mixed composition.

The ratio of phosphate ester to fire resistance improving additives may be between about between about 2.5:1 and 9:1, more preferably between about 3:1 and 8.5:1, or even more preferably between about 3.3:1 and 4.6:1.

The ratio of phosphoric acid, citric acid, acetic acid, other acidic phosphorous compounds, any acid that is stable with phosphoric acid or phosphate ester, or any combination thereof (the acidic component) to fire resistance improving additives may be between about 2:1 and 1:10, more preferably between about 1:1 and 1:8, or even more preferably between about 1:2 and 1:4.

The B-side may comprise one or more additives. The one or more additives may include minerals, reinforcing fiber, hydrophobic silica, core-shell particulate polymers, glass microspheres, or any combination thereof.

The mineral may include one or more silicate minerals. The silicate mineral may include one or more inosilicates. The inosilicate may include wollastonite. Wollastonite may improve mechanical strength, durability, adhesion, moisture resistance, impact resistance, or any combination thereof. The external shape of an individual crystal or crystal group of the one or more minerals may be acicular. Wollastonite may contain embedded metal carbonates that contribute to foaming. The acicular structure of the mineral with aspect ratios in the range of 9 to 20 may help to improve mechanical strength and durability of the reaction product. Non-limiting examples of suitable wollastonite may include NYGLOS® 12 and NYGLOS® 8, commercially available from NYCO Minerals Inc.; and Vansil® HR2000, commercially available from Vanderbilt Minerals, LLC.

Non-limiting examples of suitable hydrophobic silica may include AEROSIL® R 202 commercially available from Evonik Corporation; and CAB-O-SIL® TS-530 and TS-720, commercially available from Cabot Corporation.

An organophilic phyllosilicate may be used in place of a hydrophobic silica. An example of a suitable organophilic phyllosilicate may include Garamite-1958, commercially available from BYK-Chemie GmbH.

The two-part system may comprise one or more core-shell particulate polymers. The core-shell particulate polymer may function to improve the fracture toughness and ductility of the reaction product. Epoxy resin formulations are usually known for applications that require rigidity and high temperature resistance. Epoxies tend to be brittle. There are different strategies to reduce the brittleness of the epoxies. Often, tougheners such as core-shell polymers particles are used to reduce the brittleness and improve the ductility of the reaction product without affecting the temperature resistance significantly.

The core-shell particulate polymer may be present in the A-side, B-side, or both. The core-shell particulate polymer may be present in an amount of about 5% or more, 10% or more, or even 15% or more, by weight of the A-side or B-side. The core-shell particulate polymer may be present in an amount of about 35% or less, 30% or less, or even 25% or less, by weight of the A-side or B-side.

The core-shell particulate polymer may be pre-blended with and dispersed in an epoxy resin. The core-shell particulate polymer may be dispersed in a bisphenol A-based epoxy resin. The epoxy resin may be a liquid epoxy resin. The epoxy resin may have a viscosity, measured at 50° C., of about 16,000 cP to about 20,000 cP, more preferably 17,000 cP to 19,000 cP, or even more preferably about 18,000 cP, according to ASTM D445-21. The core-shell particulate polymer may be present in the epoxy resin in an amount of about 30% to 45%, more preferably 35% to 40%, or even more preferably about 37%. The core-shell particulate polymer may have a median particle size of about 100 nm to 300 nm, or even about 200 nm. The core-shell particulate polymer may comprise polybutadiene. Non-limiting examples of suitable core-shell particulate polymers may include Kane Ace MX-257 and MX-267, commercially available from Kaneka Corporation.

The glass microspheres may be fabricated from fused borosilicate glass. The glass microspheres may be hollow. The glass microspheres may have a bulk density of about 0.1 g/cc to 0.3 g/cc, more preferably 0.2 g/cc to 0.25 g/cc, or even more preferably about 0.22 g/cc. A non-limiting example of a suitable glass microsphere may be Sphericel® 34P30, commercially available from Potters Industries Inc.

The two-part composition may be mixed in a volumetric ratio of the A-side to the B-side. The volumetric ratio of the A-side to the B-side may be about 10:1 to 1:1, or even more preferably about 5:1 to 2:1.

### Examples

Table 1 and Table 2 presents formulations of the two-part system of the present disclosure. The volumetric ratio of the A-side to the B-side was 4:1.

TABLE 1

| | | | | | | | | |
|---|---|---|---|---|---|---|---|---|
| 7 | 8 | 47 | 48 | 50 | 51 | 53 | 54 | 56 |

A Side

| | | | | | | | | | |
|---|---|---|---|---|---|---|---|---|---|
| Epalloy ® 8250 | 54.88 | 52.33 | 51.84 | 49.56 | 47.47 | 47.47 | 44.57 | 44.57 | 46.62 |
| Epotec ® YDM 441 | 0.00 | 0.00 | 0.00 | 0.00 | 0.00 | 0.00 | 0.00 | 0.00 | 0.00 |
| Epotec ® YDF 172 | 0.00 | 0.00 | 0.00 | 0.00 | 0.00 | 0.00 | 0.00 | 0.00 | 0.00 |
| LV | | | | | | | | | |
| Epokukdo KSR 177 | 18.05 | 17.21 | 17.05 | 16.30 | 15.61 | 15.61 | 16.74 | 16.74 | 16.67 |
| D.E.R. ™ 732 | 0.00 | 0.00 | 0.00 | 0.00 | 0.00 | 4.22 | 0.00 | 4.52 | 0.00 |
| Carboxyl-terminated | 5.85 | 5.58 | 5.53 | 5.29 | 9.28 | 5.06 | 9.95 | 5.43 | 7.66 |
| epoxy/elastomer | | | | | | | | | |
| adduct | | | | | | | | | |
| Hubercarb ® Q2 | 1.46 | 1.40 | 1.84 | 1.76 | 1.69 | 1.69 | 1.36 | 1.36 | 1.58 |
| Hubercarb ® Q 200 | 1.95 | 1.86 | 2.30 | 2.20 | 2.11 | 2.11 | 1.81 | 1.81 | 2.03 |
| CAB-O-SIL ® TS | 0.24 | 0.23 | 0.23 | 0.22 | 0.21 | 0.21 | 0.23 | 0.23 | 0.23 |
| 720 | | | | | | | | | |
| APP | 14.63 | 18.60 | 18.43 | 22.03 | 21.10 | 21.10 | 22.62 | 22.62 | 22.52 |
| Exolit ® OP 935 | 2.93 | 2.79 | 2.76 | 2.64 | 2.53 | 2.53 | 2.71 | 2.71 | 2.70 |
| Total | 100.00 | 100.00 | 100.00 | 100.00 | 100.00 | 100.00 | 100.00 | 100.00 | 100.00 |

B Side

| | | | | | | | | | |
|---|---|---|---|---|---|---|---|---|---|
| Cashew nut shell | 14.63 | 14.63 | 14.63 | 14.63 | 14.63 | 14.63 | 15.87 | 15.87 | 15.23 |
| liquid -based | | | | | | | | | |
| phosphate ester | | | | | | | | | |
| 2-ethylhexyl glycidyl | 26.34 | 26.34 | 26.34 | 26.34 | 26.34 | 26.34 | 28.57 | 28.57 | 27.41 |
| ether -based | | | | | | | | | |
| phosphate ester | | | | | | | | | |
| Phenyl glycidyl | 39.02 | 39.02 | 39.02 | 39.02 | 39.02 | 39.02 | 42.33 | 42.33 | 40.61 |
| ether -based | | | | | | | | | |
| phosphate ester | | | | | | | | | |
| CAB-O-SIL ® TS | 0.49 | 0.49 | 0.49 | 0.49 | 0.49 | 0.49 | 0.53 | 0.53 | 0.51 |
| 720 | | | | | | | | | |
| H₃PO₄ 85% | 19.51 | 19.51 | 19.51 | 19.51 | 19.51 | 19.51 | 12.70 | 12.70 | 16.24 |
| Total | 100.00 | 100.00 | 100.00 | 100.00 | 100.00 | 100.00 | 100.00 | 100.00 | 100.00 |

TABLE 2

| | | | | | | | | |
|---|---|---|---|---|---|---|---|---|
| 57 | 58 | 59 | 60 | 61 | 64 | 65 | 66 | 67 |

A Side

| | | | | | | | | | |
|---|---|---|---|---|---|---|---|---|---|
| Epalloy ® 8250 | 47.70 | 47.70 | 47.48 | 47.05 | 46.62 | 50.24 | 54.47 | 55.35 | 56.25 |
| Epotec ® YDM 441 | 0.00 | 0.00 | 0.46 | 1.36 | 0.00 | 0.00 | 0.00 | 0.00 | 0.00 |
| Epotec ® YDF 172 | 0.00 | 0.00 | 0.00 | 0.00 | 16.67 | 0.00 | 0.00 | 0.00 | 0.00 |
| LV | | | | | | | | | |
| Epokukdo KSR 177 | 17.05 | 17.05 | 16.97 | 16.82 | 0.00 | 17.96 | 19.47 | 19.79 | 20.11 |
| D.E.R. ™ 732 | 0.00 | 0.00 | 0.00 | 0.00 | 0.00 | 0.00 | 0.00 | 0.00 | 0.00 |
| Carboxyl-terminated | 5.53 | 5.53 | 5.50 | 5.45 | 7.66 | 8.25 | 8.95 | 9.09 | 9.24 |
| epoxy/elastomer | | | | | | | | | |
| adduct | | | | | | | | | |
| Hubercarb ® Q2 | 1.61 | 1.61 | 1.61 | 1.59 | 1.58 | 1.70 | 1.84 | 1.87 | 1.90 |
| Hubercarb ® Q 200 | 2.07 | 2.07 | 2.06 | 2.05 | 2.03 | 2.18 | 2.37 | 2.41 | 2.45 |
| Cab-O-Sil ® TS 720 | 0.23 | 0.23 | 0.23 | 0.23 | 0.23 | 0.24 | 0.26 | 0.27 | 0.27 |
| APP | 23.04 | 21.20 | 22.94 | 22.73 | 22.52 | 19.42 | 9.47 | 9.63 | 9.78 |
| Exolit ® OP 935 | 2.76 | 4.61 | 2.75 | 2.73 | 2.70 | 0.00 | 3.16 | 1.60 | 0.00 |
| Total | 100.00 | 100.00 | 100.00 | 100.00 | 100.00 | 100.00 | 100.00 | 100.00 | 100.00 |

B Side

| | | | | | | | | | |
|---|---|---|---|---|---|---|---|---|---|
| Cashew nut shell | 15.23 | 15.23 | 15.23 | 15.23 | 15.23 | 15.23 | 15.23 | 15.23 | 15.23 |
| liquid -based | | | | | | | | | |
| phosphate ester | | | | | | | | | |
| 2-ethylhexyl glycidyl | 27.41 | 27.41 | 27.41 | 27.41 | 27.41 | 27.41 | 27.41 | 27.41 | 27.41 |
| ether -based | | | | | | | | | |
| phosphate ester | | | | | | | | | |
| Phenyl glycidyl ether- | 40.61 | 40.61 | 40.61 | 40.61 | 40.61 | 40.61 | 40.61 | 40.61 | 40.61 |
| based phosphate | | | | | | | | | |
| ester | | | | | | | | | |
| Cab-O-Sil ® TS 720 | 0.51 | 0.51 | 0.51 | 0.51 | 0.51 | 0.51 | 0.51 | 0.51 | 0.51 |
| H₃PO₄ 85% | 16.24 | 16.24 | 16.24 | 16.24 | 16.24 | 16.24 | 16.24 | 16.24 | 16.24 |
| Total | 100.00 | 100.00 | 100.00 | 100.00 | 100.00 | 100.00 | 100.00 | 100.00 | 100.00 |

Table 3 shows the fire resistance testing results for the formulations of Table 1 and Table 2. Fire resistance testing is performed according to three different standards: UL 94 V0, 12 second vertical burn according to F.A.R. 25 Appendix F Part 1 (a)(1)(ii) (3 ±0.5 mm sample thickness), and 60 second vertical burn according to F.A.R. 25 Appendix F Part 1 (a)(1)(i) (6 ±0.5 mm sample thickness).

TABLE 3

| | | | | | | Vertical 12 sec | | Vertical 60 sec | |
|---|---|---|---|---|---|---|---|---|---|
| | | UL 94 V0 | | | | Time to | Burn | Time to | Burn |
| | | Thickness | | | | extinguish | length | extinguish | length |
| Sample | Density | (mm) | t1 | t2 | t1 + t2 | (s) | (in) | (s) | (in) |
| 7 | 0.24 | 3.05 | 2 | 1 | 3 | 2.3 | 0.75 | 7.2 | N/A |
| 8 | 0.27 | 3.44 | 0 | 2 | 2 | 2.2 | 0.5 | — | — |
| 47 | 0.22 | 3.70 | 1 | 4 | 5 | 2.2 | 0.35 | 10 | N/A |
| 48 | — | 3.28 | 1 | 1 | 2 | — | — | — | — |
| 50 | — | 2.84 | 1 | 2 | 3 | 2.1 | 0.33 | — | — |
| 51 | 0.24 | 3.15 | 3 | 1 | 1 | 2.5 | 0.50 | — | — |
| 53 | — | 2.73 | 0 | 5 | 5 | 2.0 | 0.33 | — | — |
| 54 | 0.22 | 2.14 | 0 | 4 | 4 | 2.9 | 0.25 | — | — |
| 56 | 0.25 | 2.50 | 1 | 4 | 5 | 2.0 | 0.33 | 1.9 | 2.0 |
| 57 | 0.25 | 3.00 | 1 | 2 | 3 | 2.0 | 0.50 | 1.7 | 3.5 |
| 58 | 0.25 | 3.24 | 0 | 4 | 4 | 2.7 | 0.5 | — | — |
| 59 | 0.22 | 3.24 | 0 | 4 | 4 | 2.0 | 0.5 | 1.2 | 2.0 |
| 60 | 0.20 | 3.50 | 0 | 1 | 1 | 2.1 | 0.5 | — | — |
| 61 | 0.25 | 3.00 | 0 | 4 | 4 | — | — | — | — |
| 64 | — | — | — | — | — | 4.0 | 0.5 | >15 | — |
| 65 | — | — | — | — | — | 5.7 | 1.0 | 7.7 | 5.8 |
| 66 | — | — | — | — | — | 5.0 | 1.0 | >15 | — |
| 67 | — | — | — | — | — | >15 | — | >15 | — |

Samples 64-67 that include either no organic phosphinate (64) or significantly less ammonium polyphosphate (APP) (65-67) (less than 10%) perform at lower levels than comparative samples including higher levels of APP and organic phosphinate.

The self-ignition property of Sample 56 of Table 1 is measured. Self-ignition may be defined as thermal runaway and subsequent ignition due to exothermic reactions. In other words, the self-ignition temperature is the temperature at which the ignition occurs in the absence of any, and only when material is heated. Sample 56 is exposed to an increasing temperature of up to 750° C. over a period of about 5 minutes using heated air and the temperature of 750° C. was maintained for 15 minutes. A thermal barrier forms on the surface of the material and did not allow self-ignition to occur.

A flame test is performed on Sample 56 of Table 1 and Sample 60 of Table 2. The samples are exposed, for 30 seconds, to a flame measured at a temperature of 1700° C. in its hottest portion. The samples ware ignited with open flame. The applied flame is then removed and the time to extinguish the open flame was measured. The time to extinguish Sample 56 and Sample 60 is 4 seconds and 6 seconds, respectively.

Table 4 shows formulations of the two-part system according to the present disclosure. Compared to Table 1 and Table 2, the formulations of Table 4 employ an aluminum hydroxide and hollow glass microspheres. The hollow glass microspheres are added to the B-side as opposed to the A-side. This is done to balance the stoichiometric ratio where a fixed volumetric ratio was employed. Moreover, the hollow glass microspheres may function as a physical barrier to flame and provide less organic material composition per unit volume of the two-part system. These formulations are mixed at a ratio of the A-side to the B-side of about 2:1.

TABLE 4

| | 91 | 94 |
|---|---|---|
| A Side | | |
| Epalloy ® 8250 | 44.62 | 43.28 |
| Epokukdo KSR 177 | 13.36 | 12.96 |
| Carboxyl-terminated | 4.33 | 4.20 |
| epoxy/elastomer adduct | | |
| Hubercarb ® Q2 | 1.00 | 0.97 |
| Hubercarb ® Q 200 | 1.50 | 1.46 |
| CAB-O-SIL ® TS 720 | 0.18 | 0.18 |
| APP | 25.00 | 24.25 |
| Exolit ® OP 935 | 0.00 | 3.00 |
| Micral ® AM-550 | 10.00 | 9.70 |
| Total | 100.00 | 100.00 |

B Side

| | | |
|---|---|---|
| H3PO4 85% | 3.00 | 3.00 |
| Cashew nut shell liquid -based | 21.26 | 21.26 |
| phosphate ester | | |
| 2-ethylhexyl glycidyl | 33.76 | 33.76 |
| ether -based phosphate ester | | |
| Phenyl glycidyl ether -based | 29.58 | 29.58 |
| phosphate ester | | |
| CAB-O-SIL ® TS 720 | 0.40 | 0.40 |
| Sphericel ® 34P30 | 12.00 | 12.00 |
| Total | 100.00 | 100.00 |

Table 5 shows the flame-resistant testing results for the formulations of Table 4. Fire resistance testing is performed according to three different standards: UL 94 V0, 12 second vertical burn according to F.A.R. 25 Appendix F Part 1 (a)(1)(ii) (3 ±0.5 mm sample thickness), and 60 second vertical burn according to F.A.R. 25 Appendix F Part 1 (a)(1)(i) (6 ±0.5 mm sample thickness). Both sample 91 and 94 show improved performance with the glass microspheres. Only sample 94 includes the organic phosphinate and both 91 and 94 include aluminum hydroxide (Micral AM-550) and ammonium polyphosphate (APP).

TABLE 5

| | | | | | | Vertical 12 sec | | Vertical 60 sec | |
|---|---|---|---|---|---|---|---|---|---|
| | | UL 94 V0 | | | | Time to | Burn | Time to | Burn |
| | | Thickness | | | | extinguish | length | extinguish | length |
| Sample | Density | (mm) | t1 | t2 | t1 + t2 | (s) | (in) | (s) | (in) |
| 91 | 0.34 | 3.0 | 0 | 1 | 1 | — | — | — | — |
| 94 | 0.47 | 3.0 | 2 | 2 | 4 | — | — | — | — |

Table 6 shows formulations of the two-part system according to the present disclosure. These formulations are non-foaming adhesives.

TABLE 6

| Formulation | F-A-1 | F-A-4 | F-A-5 | F-A-9 |
|---|---|---|---|---|
| A side | | | | |
| KSR177 | 19.19 | 20.94 | 21.37 | 20.94 |
| DEN-426 | 15.07 | 16.44 | 16.78 | 16.44 |
| Cardolite NC-514 | 3.88 | 4.24 | 4.32 | 4.24 |
| Epoxol 9-5 (Epx. | 4.28 | 4.67 | 4.77 | 4.67 |
| Linseed oil 5.5f°) | | | | |
| Aditya Burla RD107 | 4.28 | 4.67 | 4.77 | 4.67 |
| EP01 Epoxonic Adduct | 6.46 | 7.04 | 7.19 | 7.04 |
| Kane Ace MX267 | 19.05 | 20.78 | 21.21 | 20.78 |
| Hubercarb Q200 | 1.72 | 1.87 | 1.91 | 1.87 |
| APP | 19.42 | 12.22 | 10.39 | 12.22 |
| Exolite OP935 | 2.91 | 3.05 | 3.12 | 3.05 |
| Halox SZP-391 | 2.57 | 2.81 | 2.87 | 2.81 |
| MiniFibers Shortstuff | 0.64 | 0.70 | 0.71 | 0.70 |
| ESS2F (0.96 g/cc) | | | | |
| Aerosil R208 | 0.44 | 0.48 | 0.49 | 0.48 |
| Colorant | 0.09 | 0.09 | 0.10 | 0.09 |
| Total | 100.00 | 100.00 | 100.00 | 100.00 |
| B side | | | | |
| H3PO4 85% wt. | 21.6 | 24.90 | 24.90 | 30.25 |
| MIRAMER SC1400 | 57.34 | 54.92 | 54.92 | 51.01 |
| Epoxonic 328 | 8.89 | 8.52 | 8.52 | 7.91 |
| Vansil HR2000 | 10 | 9.58 | 9.58 | 8.90 |
| Garamite 1958 | 0.89 | 0.85 | 0.85 | 0.79 |
| MiniFibers | 1.13 | 1.08 | 1.08 | 1.01 |
| Shortstuff ESS2F | | | | |
| Tronox CR-834 | 0.15 | 0.14 | 0.14 | 0.13 |
| Total (enter Batch size) | 100.00 | 100.00 | 100.00 | 100.00 |

Table 7 shows adhesive properties and flame-resistant testing results for the formulations of Table 5. Fire resistance testing is performed according to three different standards: UL 94 V0, 12 second vertical burn according to F.A.R. 25 Appendix F Part 1 (a)(1)(ii) (3 ±0.5 mm sample thickness), and 60 second vertical burn according to F.A.R. 25 Appendix F Part 1 (a)(1)(i) (6 ±0.5 mm sample thickness). All samples include ammonium polyphosphate (APP) and organic phosphinate for improving fire resistance. In addition, all samples include a phosphate methacrylate (Miramer SC1400), where sample F-A-9 includes a slightly lower amount of phosphate methacrylate.

TABLE 7

| Formulation | F-A-1 | F-A-4 | F-A-5 | F-A-9 |
|---|---|---|---|---|
| HSS EG-60 (Peak | 11.6 | 14.7 | 13.5 | 15.9 |
| Stress) .060 inch | | | | |
| CF (%) | 80% CF | 100% CF | 100% CF | 100% CF |
| Al 6022 (Peak Stress) | 9.6 | 15.3 | 14.1 | 14.9 |
| .035 inch | | | | |
| CF (%) | 40% CF | 100% CF | 100% CF | 100% CF |
| E-Coat ES-27 (Peak | 8.4 | 21.9 | 18.1 | 20.6 |
| Stress) .060 inch | | | | |
| CF (%) | 90% CF | 100% CF | 100% CF | 100% CF |
| UL-94 V0, After-flame | 2 | 0 | 6 | 1 |
| Time (t1 + t2) | | | | |
| 12 sec burn test, | 0.2 | 0.1 | 0.1 | — |
| burn length, in | | | | |
| 12 sec burn test, time | 0 | 4 | 0 | — |
| to extinguish, sec | | | | |
| 60 sec burn test, | 3.9 | 3 | 4 | — |
| burn length, in | | | | |
| 60 sec burn test, time | 3 | 0 | 0 | — |
| to extinguish, sec | | | | |

Table 8 shows formulations of the two-part system according to the present disclosure. These formulations are foaming adhesives.

TABLE 8

| | F-607-13 | F-607-14 | F-607-15 | F-607-16 |
|---|---|---|---|---|
| A side | | | | |
| YDF 170 Bis F | 13.42 | 13.42 | 13.42 | 13.12 |
| DEN 426 | 25.07 | 25.07 | 25.07 | 24.50 |
| PE-510 | 12.54 | 12.54 | 12.54 | 12.25 |
| Kane Ace MX-267 | 17.91 | 17.91 | 17.91 | 17.50 |
| KSR 177 | 4.47 | 4.47 | 4.47 | 4.37 |
| Epoxonic Adduct | 2.68 | 2.68 | 2.68 | 2.62 |
| (EP-01) | | | | |
| Q2 | 1.42 | 1.42 | 1.42 | 2.09 |
| Q 200 | 3.22 | 3.22 | 3.22 | 4.72 |
| Aerosil R208 | 1.16 | 1.16 | 1.16 | 1.13 |
| JLS - APP (Ammonium | 15.49 | 15.49 | 15.49 | 15.14 |
| Polyphosphate) | | | | |
| Exolite OP935 | 2.61 | 2.61 | 2.61 | 2.56 |
| Total | 100.00 | 100.00 | 100.00 | 100.00 |
| B side | | | | |
| Butyl Ester from | 11.33 | 10.83 | 10.32 | 10.32 |
| Isle Chem | | | | |
| Vansil HR2000 | 35.86 | 34.31 | 32.67 | 32.67 |
| Aerosil R208 | 1.68 | 1.61 | 1.53 | 1.53 |
| GE-13 | 16.04 | 15.35 | 14.62 | 14.62 |
| Epoxonic 328 | 1.42 | 1.35 | 1.29 | 1.29 |
| H3PO4 85% | 33.67 | 36.55 | 39.57 | 39.57 |
| E-773 Blue | 0.0015 | 0.0015 | 0.0015 | 0.0014 |
| Total | 100.00 | 100.00 | 100.00 | 100.00 |

Table 9 shows structural foaming adhesive properties and flame-resistant testing results for the formulations of Table 7. Fire resistance testing is performed according to the UL 94 V0 standard. From samples F-607-13 and F-607-16, there may be a trade off with modulus (both compressive and tensile) and fire resistance, though all samples pass the test with only minor differences in time that elapses. F-607-13 also includes slightly less phosphoric acid which may contribute to the slightly reduced performance.

TABLE 9

| | F-607-13 | F-607-14 | F-607-15 | F-607-16 |
|---|---|---|---|---|
| Expansion, % | 357% | 383% | 388% | 451% |
| | 50 ml | 50 ml | 50 ml | 50 ml |
| Compressive | 293.0 | 239.0 | 148.0 | 99.0 |
| Modulus (MPa) | | | | |
| Compressive Peak | 3.86 | 3.90 | 2.57 | 1.41 |
| Stress (MPa) | | | | |
| Lap Shear, 6061 T6 Al, | 6.1 | 6.2 | 7.0 | 7.7 |
| 12.7 mm overlap, 0.5 | | | | |
| mm bond-line | | | | |
| Lap Shear EG-60, 12.7 | 6.2 | 7.0 | 7.3 | 4.3 |
| mm overlap,0.5 mm | | | | |
| bond-line | | | | |
| Tensile Modulus (MPa) | 1464.3 | 922.4 | 355.3 | 193.1 |
| Tensile Peak | 7.53 | 6.70 | 3.23 | 2.27 |
| Stress (MPa) | | | | |
| Tensile Elongation (%) | 0.98 | 0.97 | 2.61 | 6.06 |
| UL 94-V0 | Pass | Pass | Pass | Pass |
| t₁ and t₂, sec | 2, 5 | 1, 2 | 0, 1 | 0, 1 |

Table 10 shows foaming adhesive formulations with the same amount of different fire-retardant additives.

TABLE 10

| | | | | | |
|---|---|---|---|---|---|
| F-607-29 | F-607-30 | F-607-31 | F-607-32 | F-607-33 | F-607-34 |

A side

| | | | | | | |
|---|---|---|---|---|---|---|
| YDF 170 Bis F | 13.50 | 13.50 | 13.50 | 13.50 | 13.50 | 13.50 |
| DEN 426 | 25.20 | 25.20 | 25.20 | 25.20 | 25.20 | 25.20 |
| PE-510 | 12.61 | 12.61 | 12.61 | 12.61 | 12.61 | 12.61 |
| Kane Ace MX-267 | 18.00 | 18.00 | 18.00 | 18.00 | 18.00 | 18.00 |
| KSR 177 | 4.50 | 4.50 | 4.50 | 4.50 | 4.50 | 4.50 |
| Epoxonic Adduct | 2.70 | 2.70 | 2.70 | 2.70 | 2.70 | 2.70 |
| Q2 | 0.72 | 0.72 | 0.72 | 0.72 | 0.72 | 0.72 |
| Q 200 | 1.62 | 1.62 | 1.62 | 1.62 | 1.62 | 1.62 |
| Aerosil R208 | 1.16 | 1.16 | 1.16 | 1.16 | 1.16 | 1.16 |
| JLS - APP (Ammonium | 20.00 | | | | | |
| Polyphosphate) | | | | | | |
| Exolite OP935 | | 20.00 | | | | |
| ATH (Aluminum Trihydrate) | | | 20.00 | | | |
| Melafine | | | | 20.00 | | |
| Melamine Pyrophosphate | | | | | 20.00 | |
| Phosgard- APP (Solid) | | | | | | 20.00 |
| Phosgard- CT (Liquid) | | | | | | |
| Phosgard - 1250 (Liquid) | | | | | | |
| Total | 100.00 | 100.00 | 100.00 | 100.00 | 100.00 | 100.00 |

B Side

| | | | | | | |
|---|---|---|---|---|---|---|
| Butyl Ester from Isle Chem | 12.46 | 12.46 | 12.46 | 12.46 | 12.46 | 12.46 |
| Vansil HR2000 | 39.45 | 39.45 | 39.45 | 39.45 | 39.45 | 39.45 |
| Aerosil R208 | 1.85 | 1.85 | 1.85 | 1.85 | 1.85 | 1.85 |
| GE-13 | 17.65 | 17.65 | 17.65 | 17.65 | 17.65 | 17.65 |
| Epoxonic 328 | 1.56 | 1.56 | 1.56 | 1.56 | 1.56 | 1.56 |
| H3PO4 85% | 27.03 | 27.03 | 27.03 | 27.03 | 27.03 | 27.03 |
| E-773 Blue | 0.0015 | 0.0015 | 0.0015 | 0.0015 | 0.0015 | 0.0015 |
| Total | 100.00 | 100.00 | 100.00 | 100.00 | 100.00 | 100.00 |

Table 11 shows structural foaming adhesive properties and flame-resistant testing results for the formulations of Table 10. Fire resistance testing is performed according to the UL 94 V0 standard. Improved results are realized in samples F-607-29 and F-607-30 which utilized ammonium polyphosphate (29) and organic phosphinate (30) for fire resistance additives.

TABLE 11

| Flame -Retardant | F-607-29 | F-607-30 | F-607-31 | F-607-32 | F-607-33 | F-607-34 |
|---|---|---|---|---|---|---|
| Expansion % | 149 | 26 | 72 | 72 | 149 | 139 |
| Compressive Modulus/Foam Density | 1001 | 1026 | 377 | 488 | 1129 | 1057 |
| (MPa * mL/g) | | | | | | |
| Tensile Modulus | 3766 | 2998 | 5983 | 3460 | 4416 | 3643 |
| Tensile Elongation % | 1.03 | 0.76 | 0.26 | 0.67 | 0.56 | 0.31 |
| UL94-V0 After-flame Time (t1 + t2) | 3 | 0 | Fail | Fail | 6 | 12 |

Table 12 shows foaming adhesive formulations with epoxy DOPO (9,10-Dihydro-9-oxa-10-phosphaphenanthrene-10-oxide) reaction products from Springfield Industries. In this experiment, 3 different epoxy/DOPO products (18.7P, 18.7AG, and 18.7 AF) are used in two different levels and results were compared with the reference (F-607-5). The use of the DOPO reaction products showed improved fire-resistance, with the use of RD114 with DOPO (18.7AF) ((3.6% P)) showing particular improvement (F-607-19 and F-607-22).

TABLE 12

| | | | | | | |
|---|---|---|---|---|---|---|
| F-607-5 | F-607-17 | F-607-18 | F-607-19 | F-607-20 | F-607-21 | F-607-22 |

A side

| | | | | | | | |
|---|---|---|---|---|---|---|---|
| YDF 170 Bis F | 13.00 | 6.08 | 6.08 | 6.08 | 0.00 | 0.00 | 0.00 |
| DEN 426 | 24.27 | 22.70 | 22.70 | 22.70 | 21.59 | 21.59 | 21.59 |
| PE-510 | 12.14 | 11.73 | 11.73 | 11.73 | 11.16 | 11.16 | 11.16 |
| GE31 with DOPO (18.7P) ((4% P)) | 0.00 | 12.16 | 0.00 | 0.00 | 22.24 | 0.00 | 0.00 |
| Heloxy with DOPO (18.7AG) ((5.3% P)) | 0.00 | 0.00 | 12.16 | 0.00 | 0.00 | 22.24 | 0.00 |
| RD114 with DOPO (18.7AF) ((3.6% P)) | 0.00 | 0.00 | 0.00 | 12.16 | 0.00 | 0.00 | 22.24 |
| Kane Ace MX-267 | 17.33 | 16.21 | 16.21 | 16.21 | 15.42 | 15.42 | 15.42 |
| KSR 177 | 4.33 | 4.05 | 4.05 | 4.05 | 3.85 | 3.85 | 3.85 |
| Epoxonic 328 Adduct | 2.60 | 2.43 | 2.43 | 2.43 | 2.31 | 2.31 | 2.31 |
| Q2 | 0.69 | 0.64 | 0.64 | 0.64 | 0.61 | 0.61 | 0.61 |
| Q 200 | 1.56 | 1.46 | 1.46 | 1.46 | 1.39 | 1.39 | 1.39 |
| Aerosil R208 | 1.12 | 1.05 | 1.05 | 1.05 | 1.00 | 1.00 | 1.00 |
| JLS - APP (Ammonium Polyphosphate) | 20.63 | 19.29 | 19.29 | 19.29 | 18.35 | 18.35 | 18.35 |
| Exolite OP935 | 2.34 | 2.19 | 2.19 | 2.19 | 2.09 | 2.09 | 2.09 |
| Total | 100.00 | 100.00 | 100.00 | 100.00 | 100.00 | 100.00 | 100.00 |

B Side

| | | | | | | | |
|---|---|---|---|---|---|---|---|
| Butyl Ester from Isle Chem | 12.46 | 12.46 | 12.46 | 12.46 | 12.46 | 12.46 | 12.46 |
| Vansil HR2000 | 39.45 | 39.45 | 39.45 | 39.45 | 39.45 | 39.45 | 39.45 |
| Aerosil R208 | 1.85 | 1.85 | 1.85 | 1.85 | 1.85 | 1.85 | 1.85 |
| GE-13 | 17.65 | 17.65 | 17.65 | 17.65 | 17.65 | 17.65 | 17.65 |
| Epoxonic 328 | 1.56 | 1.56 | 1.56 | 1.56 | 1.56 | 1.56 | 1.56 |
| H3PO4 85% | 27.03 | 27.03 | 27.03 | 27.03 | 27.03 | 27.03 | 27.03 |
| E-773 Blue | 0.0015 | 0.0015 | 0.0015 | 0.0015 | 0.0015 | 0.0015 | 0.0015 |
| Total | 100.00 | 100.00 | 100.00 | 100.00 | 100.00 | 100.00 | 100.00 |

Table 13 shows structural foaming adhesive properties and flame-resistant testing results for the formulations of Table 11. Fire resistance testing is performed according to the UL 94 V0 standard.

TABLE 13

| Flame-Retardant | F-607-5 | F-607-17 | F-607-18 | F-607-19 | F-607-20 | F-607-21 | F-607-22 |
|---|---|---|---|---|---|---|---|
| UL94-V0 Burn Test | Pass | Pass | Pass | Pass | Pass | Pass | Pass |
| After-flame Time (t1 + t2) | 3 | 1 | 2 | 0 | 1 | 1 | 0 |
| Lap Shear Peak Stress, Al | 7.50 | 7.63 | 9.52 | 10.03 | 8.28 | 7.24 | 12.4 |
| 6022 (MPa) | | | | | | | |
| Lap Shear Peak Stress, HSS | 4.10 | 6.94 | 5.90 | 8.20 | 6.78 | 7.88 | 7.14 |
| EG60 (MPa) | | | | | | | |

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time, and the like is, for example, from 1 to 90, from 20 to 80, or from 30 to 70, it is intended that intermediate range values such as (for example, 15 to 85, 22 to 68, 43 to 51, 30 to 32, etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints.

As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

The disclosures of all articles and references, including patent applications and publications, are incorporated by reference for all purposes. Other combinations are also possible as will be gleaned from the following claims, which are also hereby incorporated by reference into this written description.

1. A fire-resistant two-part system comprising:
a first component; comprising one or more epoxy resins; and
a second component comprising one or more acid esters; and
wherein the fire-resistant two-part system comprises one or more fire resistance improving additives.

2. The fire-resistant two-part system according to claim 1, which cures to form a reaction product when the first component and the second component are mixed with one another.

3. The fire-resistant two-part system according to claim 2, wherein curing initiates immediately upon mixing the first component and the second component with one another, at room temperature (23° C.).

4. The fire-resistant two-part system according to claim 2, wherein curing is delayed for a time after mixing the first component and the second component with one another, at room temperature (23° C.).

5. The fire-resistant two-part system according to claim 1, which is free of latent curing agents, curing accelerators, or both.

6. (canceled)

7. The fire-resistant two-part system according to claim 5, wherein the one or more fire resistance improving additives include a phosphorous-based material, a metal hydroxide, or both.

8. The fire-resistant two-part system according to claim 7, wherein the phosphorous-based material is 9,10-Dihydro-9-oxa-10-phosphaphenanthrene 10-oxide, an ammonium polyphosphate, an organic phosphinate, or any combination thereof.

9. The fire-resistant two-part system according to claim 8, wherein the ammonium polyphosphate is linear, preferably short linear chained (n<1000), or branched, preferably long branched chained (n>1000).

10. (canceled)

11. The fire-resistant two-part system according to claim 8, wherein the ammonium polyphosphate is present in the first component in an amount of about 25% or less, 19% or less, or even 15% or less, by weight of the first component.

12. The fire-resistant two-part system according to claim 8, including an organic phosphinate and wherein the organic phosphinate functions to decompose when heated and releases diethyl phosphinic acid in the gas phase.

13-14. (canceled)

15. The fire-resistant two-part system according to claim 7, wherein the metal hydroxide is aluminum hydroxide, magnesium hydroxide, or both.

16. (canceled)

17. The fire-resistant two-part system according to claim 7, wherein the fire resistance improving additives have a particle size of about 20 microns or less, 10 microns or less, or even 5 microns or less.

18-19. (canceled)

20. The fire-resistant two-part system according to claim 1, wherein the one or more epoxy resins includes one or more multifunctional aromatic epoxy resins, multifunctional aliphatic epoxy resins, epoxy novolac resins, silane modified epoxy resins, epoxy/elastomer adducts, or any combination thereof.

21. The fire-resistant two-part system according to claim 20, wherein the functionality of the multifunctional aromatic and/or aliphatic epoxy resin is about 2 or more, 3 or more, or even 4 or more.

22-55. (canceled)

55. The fire-resistant two-part system according to claim 1, wherein the one or more acid esters are reaction products of a mono-epoxide with phosphoric acid; preferably selected from mono-esters, di-esters, and tri-esters.

56. The fire-resistant two-part system according to claim 55, wherein the one or more acid esters include cashew nut shell liquid-based phosphate esters, 2-ethylhexyl glycidyl ether-based phosphate esters, phenyl glycidyl ether-based phosphate esters, or any combination thereof.

57-58. (canceled)

59. The fire-resistant two-part system according to claim 55, wherein the one or more acid esters is present in the second component in an amount of between about 40% and 95%, more preferably between about 50% and 80%, or even more preferably between about 60% and 70%, by weight of the second component.

60. (canceled)

61. The fire-resistant two-part system according to claim 55, wherein the weight ratio of the one or more acid esters to fire resistance improving additives is between about 2.5:1 and 9:1, preferably between about 3:1 and 8.5:1, or even between about 3.3:1 and 4.6:1.

62. The fire resistant two-part system according to claim 55, wherein the weight ratio of the second component to the fire resistance improving additives is between about 2:1 and 1:10, preferably between about 1:1 and 1:8, or even between about 1:2 and 1:4.

63-66. (canceled)

67. A composition comprising:
a first component comprising one or more epoxy resins and one or more fire resistance improving additives; and
a second component comprising one or more curatives selected from acids and acid esters;
wherein the fire resistance improving additives are selected from ammonium polyphosphate, organic phosphinate, or some combination thereof.

68-69. (canceled)
